(19) United States
(12) Patent Application Publication
(10) Pub. No.: US 2024/0322228 A1
(43) Pub. Date: Sep. 26, 2024

(54) BATTERY

(71) Applicant: Panasonic Intellectual Property Management Co., Ltd., Osaka (JP)

(72) Inventors: Yumi MIYAMOTO, Osaka (JP); Mitsuhiro MURATA, Hyogo (JP)

(21) Appl. No.: 18/732,482

(22) Filed: Jun. 3, 2024

Related U.S. Application Data
(63) Continuation of application No. PCT/JP2022/043536, filed on Nov. 25, 2022.

(30) Foreign Application Priority Data
Dec. 7, 2021 (JP) 2021-198904

(51) Int. Cl. H01M 10/0562; H01M 4/02; H01M 4/131; H01M 4/525

(52) U.S. Cl. CPC H01M 10/0562; H01M 4/131; H01M 4/525; H01M 2004/028; H01M 2300/008; H01M 2300/0094

(57) ABSTRACT

A battery of the present disclosure includes a positive electrode, a negative electrode, and a solid electrolyte layer positioned between the positive electrode and the negative electrode. The positive electrode includes a positive electrode material. The positive electrode material includes a positive electrode active material and a first solid electrolyte material. The positive electrode active material includes a material represented by composition formula (1): (Li_{2-α1}M1_{α1})O. In the composition formula (1), M1 is at least one selected from the group consisting of transition metal elements, and α1 satisfies 0<α1<2.

This application is a continuation of PCT/JP2022/043536 filed on Nov. 25, 2022, which claims foreign priority of Japanese Patent Application No. 2021-198904 filed on Dec. 7, 2021, the entire contents of both of which are incorporated herein by reference.

### BACKGROUND OF THE INVENTION

### 1. Field of the Invention

The present disclosure relates to a battery.

### 2. Description of Related Art

JP 2006-244734 A discloses an all-solid-state secondary battery including a solid electrolyte formed of a compound containing indium as a cation and a halogen element as an anion. According to the reference made by JP 2006-244734 A, in the above all-solid-state secondary battery, a desirable average potential of the positive electrode active material is 3.9 V or less vs. Li, and this suppresses generation of a coating formed of an oxidative decomposition product of the solid electrolyte and thus achieves favorable charge and discharge characteristics. JP 2006-244734 A also discloses, as positive electrode active materials having an average potential of 3.9 V or less vs. Li, layered transition metal oxides such as LiCoO₂ and LiNi_{0.8}Co_{0.15}Al_{0.05}O₂.

JP 2015-32515 A discloses a transition metal solid solution alkali metal oxide having a structure in which transition metal atoms (e.g., cobalt or iron atoms) are solid-dissolved in the crystal structure of an alkali metal oxide. JP 2015-32515 A also discloses an electrode material including the above transition metal solid solution alkali metal oxide as the active material.

### SUMMARY OF THE INVENTION

The present disclosure provides a novel battery including a solid electrolyte and including a positive electrode operable in a potential range where no decomposition of the solid electrolyte occurs.

A battery of the present disclosure includes:
a positive electrode;
a negative electrode; and
a solid electrolyte layer positioned between the positive electrode and the negative electrode, wherein
the positive electrode includes a positive electrode material,
the positive electrode material includes a positive electrode active material and a first solid electrolyte material, and
the positive electrode active material includes a material represented by the following composition formula (1):

(Li_{2-α1}M1_{α1})O Formula (1)
in the composition formula (1),
M1 is at least one selected from the group consisting of transition metal elements, and
α1 satisfies 0<α1<2.

The present disclosure provides a novel battery including a solid electrolyte and including a positive electrode operable in a potential range where no decomposition of the solid electrolyte occurs.

### BRIEF DESCRIPTION OF THE DRAWINGS

FIG. 1 is a cross-sectional view schematically showing the configuration of a battery 2000 according to Embodiment 1.

FIG. 2 is a cross-sectional view schematically showing the configuration of a battery 3000 according to Embodiment 2.

FIG. 3 is a graph showing the charge and discharge curves of a battery of Example 1.

FIG. 4 is a graph showing the charge and discharge curves of a battery of Example 2.

FIG. 5 is a graph showing the charge and discharge curves of a battery of Example 3.

FIG. 6 is a graph showing the charge and discharge curves of a battery of Example 4.

FIG. 7 is a graph showing the charge and discharge curves of a battery of Example 5.

FIG. 8 is a graph showing the charge and discharge curves of a battery of Example 6.

FIG. 9 is a graph showing the charge and discharge curves of a battery of Example 7.

FIG. 10 is a graph showing the charge and discharge curves of a battery of Example 8.

FIG. 11 is a graph showing the X-ray diffraction (XRD) pattern of the positive electrode active material produced in Example 1.

FIG. 12 is a graph showing the XRD pattern of the positive electrode active material produced in Example 3.

FIG. 13 is a graph showing the XRD pattern of the positive electrode active material produced in Example 5.

FIG. 14 is a graph showing the XRD pattern of the positive electrode active material produced in Example 7.

### DETAILED DESCRIPTION

### Findings Underlying the Present Disclosure

As described in JP 2006-244734 A too, described in 2. Description of Related Art section above, since a battery including a solid electrolyte has a problem of decomposition of the solid electrolyte during charge of the battery, a desirable average potential of the positive electrode active material during charge of the battery is considered to be 3.9 V or less vs. Li. In view of this, the present disclosure has focused on, as the material for the positive electrode active material, a material based on Li₂O, which can achieve an average potential of 3.9 V or less vs. Li during charge and has a high theoretical capacity. Introducing a transition metal cation into the tetrahedral site of Li₂O enables charge and discharge, and thus enables charge and discharge at a potential of 3.9 V or less vs. Li. As described above, JP 2015-32515 A discloses an electrode material including, as the active material, a transition metal solid solution alkali metal oxide having a structure in which transition metal atoms are solid-dissolved in the crystal structure of an alkali metal oxide such as Li₂O. In JP 2015-32515 A, however, studies are conducted on the application of the above electrode material to the electrode of a flooded battery, while no specific studies are conducted on the application of the above electrode material to the electrode of a solid-state battery including a solid electrolyte. In view of this, the present inventors have conducted extensive studies as to whether a positive electrode material based on Li₂O can operate in a solid-state battery including a solid electrolyte.

A flooded battery using a material based on Li₂O as the electrode material has a problem in which during charge, peroxide ions become eluted into the electrolyte solution and thus generate oxygen gas. In contrast, in a solid-state battery using a material based on Li₂O as the electrode material, elution of peroxide ions and thus generation of oxygen gas are presumably suppressed.

The present inventors have conducted further studies based on the above findings, and as a result, have completed the battery of the present disclosure described below.

### Outline of One Aspect According to the Present Disclosure

A battery according to a first aspect of the present disclosure includes:
a positive electrode;
a negative electrode; and
a solid electrolyte layer positioned between the positive electrode and the negative electrode, wherein
the positive electrode includes a positive electrode material,
the positive electrode material includes a positive electrode active material and a first solid electrolyte material, and
the positive electrode active material includes a material represented by the following composition formula (1):

(Li_{2-α1}M1_{α1})O Formula (1)
in the composition formula (1),
M1 is at least one selected from the group consisting of transition metal elements, and
α1 satisfies 0<α1<2.

According to the first aspect, it is possible to provide a novel battery including a solid electrolyte and including a positive electrode operable in a potential range where no decomposition of the solid electrolyte occurs.

In a second aspect, for example, the battery according to the first aspect may be such that the M1 is at least one selected from the group consisting of Fe, Co, Ni, and Cu.

The battery according to the second aspect can achieve a higher capacity.

In a third aspect, for example, the battery according to the first or second aspect may be such that the first solid electrolyte material includes: Li; at least one selected from the group consisting of metalloid elements and metal elements other than Li; and at least one selected from the group consisting of Cl and Br.

The battery according to the third aspect can have a further enhanced ionic conductivity of the first solid electrolyte material. Consequently, the battery according to the third aspect can have a further reduced resistance resulting from the migration of Li ions in the positive electrode material, thereby more effectively suppressing an increase in the internal resistance of the battery during charge.

In a fourth aspect, for example, the battery according to the third aspect may be such that the first solid electrolyte material includes a material represented by the following composition formula (2):

Li_{α2}M2_{β2}X_{γ2}O_{δ2} Formula (2)
in the composition formula (2),
α2, β2, and γ2 are each a value greater than 0, and δ2 is a value equal to or greater than 0,
M2 is at least one selected from the group consisting of metalloid elements and metal elements other than Li, and
X is at least one selected from the group consisting of Cl and Br.

The battery according to the fourth aspect can have a further enhanced ionic conductivity of the first solid electrolyte material. Consequently, the battery according to the fourth aspect can have a further reduced resistance resulting from the migration of Li ions in the positive electrode material, thereby more effectively suppressing an increase in the internal resistance of the battery during charge.

In a fifth aspect, for example, the battery according to the fourth aspect may be such that the M2 includes at least one selected from the group consisting of Y and Ta.

The battery according to the fifth aspect can have a further enhanced ionic conductivity of the first solid electrolyte material. Consequently, the battery according to the fifth aspect can have a further reduced resistance resulting from the migration of Li ions in the positive electrode material, thereby more effectively suppressing an increase in the internal resistance of the battery during charge.

In a sixth aspect, for example, the battery according to the fourth or fifth aspect may be such that the composition formula (2) satisfies:

$$1 \leq α2 \leq 4 ;$$

$$0 < β2 \leq 2 ;$$

$$3 \leq γ2 < 7 ; and$$

$$0 \leq δ2 \leq 2.$$

The battery according to the sixth aspect can have a further enhanced ionic conductivity of the first solid electrolyte material. Consequently, the battery according to the sixth aspect can have a further reduced resistance resulting from the migration of Li ions in the positive electrode material, thereby more effectively suppressing an increase in the internal resistance of the battery during charge.

In a seventh aspect, for example, the battery according to any one of the first to sixth aspects may be such that the first solid electrolyte material includes a sulfide solid electrolyte.

The battery according to the seventh aspect can have a further enhanced ionic conductivity of the first solid electrolyte material. Consequently, the battery according to the seventh aspect can have a further reduced resistance resulting from the migration of Li ions in the positive electrode material, thereby more effectively suppressing an increase in the internal resistance of the battery during charge.

In an eighth aspect, for example, the battery according to the seventh aspect may be such that the sulfide solid electrolyte is Li₆PS₅Cl.

The battery according to the eighth aspect can have a further enhanced ionic conductivity of the first solid electrolyte material. Consequently, the battery according to the eighth aspect can have a further reduced resistance resulting from the migration of Li ions in the positive electrode material, thereby more effectively suppressing an increase in the internal resistance of the battery during charge.

In a ninth aspect, for example, the battery according to any one of the first to eighth aspects may be such that the solid electrolyte layer includes a first solid electrolyte layer and a second solid electrolyte layer, and the second solid electrolyte layer is positioned between the first solid electrolyte layer and the negative electrode.

In the battery according to the ninth aspect, an increase in internal resistance during charge can be suppressed.

In a tenth aspect, for example, the battery according to any one of the first to ninth aspects may be such that the positive electrode active material further includes a composite oxide including Li and the M1.

The battery according to the tenth aspect can have an enhanced charge and discharge efficiency.

### Embodiments of the Present Disclosure

Embodiments of the present disclosure will be described below with reference to the drawings. The following descriptions are each a generic or specific example. The numerical values, composition, shape, film thickness, electrical characteristics, battery structure, etc., shown below are illustrative only, and are not intended to limit the present disclosure.

### Embodiment 1

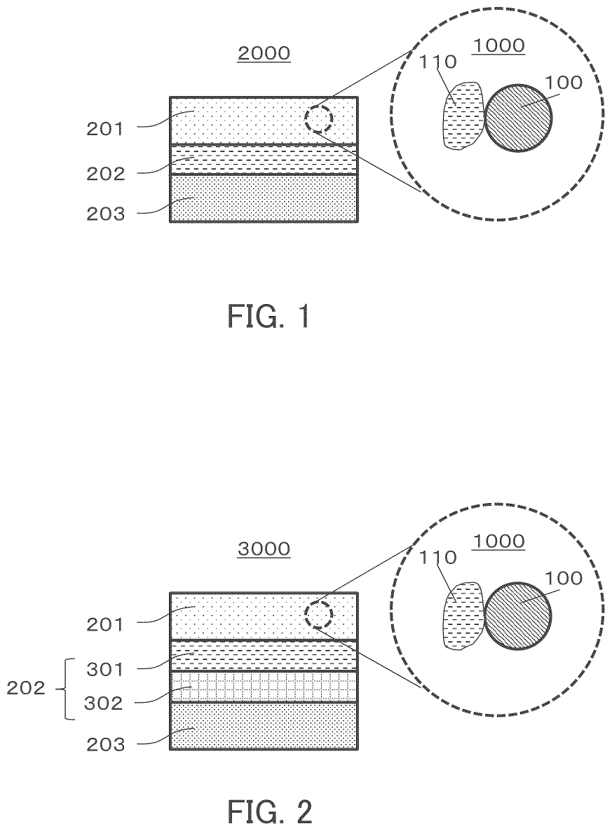

FIG. 1 is a cross-sectional view schematically showing the configuration of a battery 2000 according to Embodiment 1.

The battery 2000 includes a positive electrode 201, a negative electrode 203, and a solid electrolyte layer 202 positioned between the positive electrode 201 and the negative electrode 203. The positive electrode 201 includes a positive electrode material 1000. The positive electrode material 1000 includes a positive electrode active material 110 and a first solid electrolyte material 100. The positive electrode active material 110 includes a material represented by the following composition formula (1):

(Li_{2-α1}M1_{α1})O Formula (1)
in the composition formula (1), M1 is at least one selected from the group consisting of transition metal elements, and α1 satisfies 0<α1<2.

The positive electrode 201 of the battery 2000 is operable in a potential range where no decomposition of the solid electrolyte occurs. The potential range where no decomposition of the solid electrolyte occurs is, for example, a range where the average potential is 3.9 V or less vs. Li.

The constituent elements of the battery 2000 according to the present embodiment will be described below.

### [Positive Electrode 201]

As described above, the positive electrode 201 includes the positive electrode material 1000. The positive electrode material 1000 includes the positive electrode active material 110 and the first solid electrolyte material 100. The positive electrode active material 110 includes the material represented by the above composition formula (1).

The fact that the positive electrode active material 110 includes the material represented by the composition formula (1), that is, a material represented by (Li_{2-α1}M1_{α1})O can be determined by, for example: performing θ-2θ XRD measurement using Cu-Kα radiation (wavelengths of 1.5405 Å and 1.5444 Å, that is, wavelengths of 0.15405 nm and 0.15444 nm) to obtain the XRD pattern of the positive electrode active material 110; and confirming that the XRD pattern has a peak derived from the Li₂O skeleton.

The positive electrode active material 110 may include the material represented by the composition formula (1) as the main component. The “main component” as used herein refers to a component having the highest mass content. In this case, the fact that the positive electrode active material 110 includes the material represented by the composition formula (1) as the main component can be determined, for example, from the peak intensity (peak height) of a peak derived from the Li₂O skeleton in the XRD pattern of the positive electrode active material 110 obtained by the above XRD measurement. Moreover, the positive electrode active material 110 may consist of the material represented by the composition formula (1). In this case, the fact that the positive electrode active material 110 consists of the material represented by the composition formula (1) can be determined by confirming that the XRD pattern obtained by the above XRD measurement has no peak other than the peak derived from the Li₂O skeleton, except for an impurity peak.

The material represented by the composition formula (1) may be, for example, a material having a Li₂O skeleton having a structure in which atoms of a transition metal element M1 are solid-dissolved in the crystal structure of Li₂O. A material having a Li₂O skeleton such as above is hereinafter referred to as a “Li₂O-based material”. The Li₂O-based material is a material based on Li₂O, which has a high theoretical capacity (e.g., 897 mAh/g). Therefore, in the case where the positive electrode active material 110 includes the Li₂O-based material, it is possible to achieve a higher capacity of the battery 2000.

To achieve an even higher capacity, the positive electrode active material 110 may include the Li₂O-based material as the main component. In this case, the fact that the positive electrode active material 110 includes the Li₂O-based material as the main component can be determined, for example, from the magnitude of the peak intensity of a peak derived from the Li₂O skeleton, the presence of a peak not derived from the Li₂O skeleton, and the magnitude of the peak intensity of the peak not derived from the Li₂O skeleton in the XRD pattern of the positive electrode active material 110. The positive electrode active material 110 may consist of the Li₂O-based material, except for unavoidably incorporated impurities.

In the composition formula (1), M1 may be at least one selected from the group consisting of Fe, Co, Ni, and Cu. M1 may be at least one selected from the group consisting of Co, Ni, and Cu. In the case where M1 included in the material represented by the composition formula (1) is any of the above elements, the battery 2000 can achieve a higher capacity.

The positive electrode active material 110 may further include a composite oxide including Li and M1. In the case where the positive electrode active material 110 further includes the composite oxide including Li and M1, the battery 2000 can have an enhanced charge and discharge efficiency.

The first solid electrolyte material 100 may include: Li; at least one selected from the group consisting of metalloid elements and metal elements other than Li; and at least one selected from the group consisting of Cl and Br.

The “metalloid elements” refer to B, Si, Ge, As, Sb, and Te.

The “metal elements” refer to all the elements included in Groups 1 to 12 of the periodic table except hydrogen and all the elements included in Groups 13 to 16 of the periodic table except B, Si, Ge, As, Sb, Te, C, N, P, O, S, and Se. In other words, the “metalloid elements” and the “metal elements” are each a group of elements that can become a cation when forming an inorganic compound with a halogen compound.

With the above configuration, the positive electrode material 1000 has a high oxidation resistance. Consequently, it is possible to suppress an increase in the internal resistance of the battery 2000 during charge.

The first solid electrolyte material 100 may be represented by the following composition formula (2):

Li_{α2}M2_{β2}X_{γ2}O_{δ2} Formula (2)
in the composition formula (2), α2, β2, and γ2 are each a value greater than 0, δ2 is a value equal to or greater than 0, M2 is at least one selected from the group consisting of metalloid elements and metal elements other than Li, and X is at least one element selected from the group consisting of Cl and Br.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

In the composition formula (2), M2 may include at least one selected from the group consisting of Y and Ta. In the composition formula (2), M2 may include Y. In other words, the first solid electrolyte material 100 may include Y as a metal element.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

In the composition formula (2), 1≤α2≤4, 0<β2≤2, 3≤γ2<7, and 0≤δ2≤2 may be satisfied.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

In the composition formula (2), 2.5≤α2≤3, 1≤β2≤1.1, γ2=6, and δ2=0 may be satisfied.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 including Y may be, for example, a compound represented by a composition formula LiₐMe_{b}Y_{c}X₆, where a+m′b+3c=6 and c>0 are satisfied, Me is at least one element selected from the group consisting of metalloid elements and metal elements other than Li or Y, and m′ is the valence of Me.

Me may be at least one element selected from the group consisting of Mg, Ca, Sr, Ba, Zn, Sc, Al, Ga, Bi, Zr, Hf, Ti, Sn, Ta, and Nb.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 may be a material represented by the following composition formula (A1):

Li_{6-3d}Y_{d}X₆ Formula (A1)
in the composition formula (A1), X is a halogen element and includes Cl, and 0<d<2 is satisfied.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 may be a material represented by the following composition formula (A2):

Li₃YX₆ Formula (A2)
in the composition formula (A2), X is a halogen element and includes Cl.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 may include Li₃YBr₂Cl₄. The first solid electrolyte material 100 may be Li₃YBr₂Cl₄.

The first solid electrolyte material 100 may be a material represented by the following composition formula (A3):

Li_{3-3δ}Y_{1+δ}Cl₆ Formula (A3)
in the composition formula (A3), 0<δ≤0.15 is satisfied.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 may be a material represented by the following composition formula (A4):

Li_{3-3δ+a4}Y_{1+δ-a4}Meₐ₄Cl₆₋ₓ₄Brₓ₄ Formula (A4)
in composition formula (A4), Me is at least one element selected from the group consisting of Mg, Ca, Sr, Ba, and Zn, and −1<δ<2, 0<a4<3, 0<(3−3δ+a4), 0<(1+δ−a4), and 0≤x4<6 are satisfied.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 may be a material represented by the following composition formula (A5):

Li_{3-3δ}Y_{1+δ-a5}Meₐ₅Cl₆₋ₓ₅Brₓ₅ Formula (A5)
in the composition formula (A5), Me is at least one element selected from the group consisting of Al, Sc, Ga, and Bi, and −1<δ<1, 0<a5<2, 0<(1+δ−a5), and 0≤x5<6 are satisfied.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 may be a material represented by the following composition formula (A6):

Li_{3-3δ-a6}Y_{1+δ-a6}Meₐ₆Cl₆₋ₓ₆Brₓ₆ Formula (A6)
in the composition formula (A6), Me is at least one element selected from the group consisting of Zr, Hf, and Ti, and −1<δ<1, 0<a6<1.5, 0<(3−3δ−a6), 0<(1+δ−a6), and 0≤x6<6 are satisfied.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 may be a material represented by the following composition formula (A7):

Li_{3-3δ-2a7}Y_{1+δ-a7}Meₐ₇Cl₆₋ₓ₇Brₓ₇ Formula (A7)
in the composition formula (A7), Me is at least one element selected from the group consisting of Ta and Nb, and −1<δ<1, 0<a7<1.2, 0<(3−3δ-2a7), 0<(1+δ−α7), and 0≤x7<6 are satisfied.

With the above configuration, the battery 2000 can have a further enhanced ionic conductivity of the first solid electrolyte material 100. Consequently, the battery 2000 can have a further reduced resistance resulting from the migration of Li ions in the positive electrode material 1000, thereby more effectively suppressing an increase in the internal resistance of the battery 2000 during charge.

The first solid electrolyte material 100 can be, for example, Li₃YX₆, Li₂MgX₄, Li₂FeX₄, Li(Al, Ga, In)X₄, or Li₃(Al, Ga, In)X₆, where X includes Cl. In the present disclosure, when an element in a formula is expressed as, for example, “(Al, Ga, In)”, this expression indicates at least one element selected from the group of elements in parentheses. In other words, “(Al, Ga, In)” is synonymous with “at least one selected from the group consisting of Al, Ga, and In”. The same applies to other elements.

The first solid electrolyte material 100 may include a sulfide solid electrolyte. The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or Li₆PS₅Cl. Furthermore, LiX, Li₂O, MO_{q}, LiₚMO_{q}, or the like may be added to the above, where X is at least one element selected from the group consisting of F, Cl, Br, and I, M is at least one element selected from the group consisting of P, Si, Ge, B, Al, Ga, In, Fe, and Zn, and p and q are each independently a natural number.

The first solid electrolyte material 100 may include lithium sulfide and phosphorus sulfide. The sulfide solid electrolyte may be at least one selected from the group consisting of Li₂S—P₂S₅ and Li₆PS₅Cl. The sulfide solid electrolyte may be LisPS₅Cl.

The shape of the first solid electrolyte material 100 is not particularly limited. In the case where the first solid electrolyte material 100 is in the form of a powdered material, its shape may be, for example, an acicular shape, a spherical shape, or an ellipsoidal shape. The first solid electrolyte material 100 may be, for example, particulate.

For example, in the case where the first solid electrolyte material 100 is particulate (e.g., spherical), the first solid electrolyte material 100 may have a median diameter of 100 μm or less. In the case where the first solid electrolyte material 100 has a median diameter of 100 μm or less, the positive electrode active material 110 and the first solid electrolyte material 100 can form a favorable dispersion state in the positive electrode material 1000. This enhances the charge and discharge characteristics of the battery 2000.

The first solid electrolyte material 100 may have a median diameter of 10 μm or less. With the above configuration, the positive electrode active material 110 and the first solid electrolyte material 100 can form a favorable dispersion state in the positive electrode material 1000.

In Embodiment 1, the first solid electrolyte material 100 may have a smaller median diameter than the positive electrode active material 110 has. With the above configuration, the positive electrode active material 110 and the first solid electrolyte material 100 can form a more favorable dispersion state in the positive electrode.

The positive electrode active material 110 may have a median diameter of 0.1 μm or more and 100 μm or less.

In the case where the positive electrode active material 110 has a median diameter of 0.1 μm or more, the positive electrode active material 110 and the first solid electrolyte material 100 can form a favorable dispersion state in the positive electrode material 1000. This enhances the charge and discharge characteristics of a battery using the positive electrode material 1000. In the case where the positive electrode active material 110 has a median diameter of 100 μm or less, lithium diffuses at an enhanced rate in the positive electrode active material 110. This enables the battery 2000 to operate at a high output.

The positive electrode active material 110 may have a larger median diameter than the first solid electrolyte material 100 has. With the above configuration, the positive electrode active material 110 and the first solid electrolyte material 100 can form a favorable dispersion state.

In the present disclosure, the “median diameter” means the particle diameter at a cumulative volume equal to 50% in the volumetric particle size distribution. The volumetric particle size distribution is measured with, for example, a laser diffractometer or an image analyzer.

The positive electrode material 1000 may further include a positive electrode active material other than the positive electrode active material 110.

The positive electrode active material 110 includes a material having properties of occluding and releasing metal ions (e.g., lithium ions). The positive electrode active material other than the positive electrode active material 110 can be, for example, a lithium-containing transition metal oxide, a transition metal fluoride, a polyanion material, a fluorinated polyanion material, a transition metal sulfide, a transition metal oxysulfide, or a transition metal oxynitride. Examples of the lithium-containing transition metal oxide include Li(Ni, Co,Al)O₂, Li(Ni, Co, Mn)O₂, and LiCoO₂. In particular, in the case where the lithium-containing transition metal oxide is used, it is possible to reduce the manufacturing cost of the positive electrode material 1000 and enhance the average discharge voltage.

The positive electrode material 1000 included in the battery 2000 according to Embodiment 1 may include a plurality of the first solid electrolyte materials 100 and a plurality of the positive electrode active materials 110.

In the positive electrode material 1000, the content of the first solid electrolyte material 100 and the content of the positive electrode active material 110 may be equal to or different from each other.

In the positive electrode material 1000, the first solid electrolyte material 100 and the positive electrode active material 110 may be in contact with each other as shown in FIG. 1.

In the volume ratio “v1:100-v1” between the positive electrode active material 110 and the first solid electrolyte material 100 included in the positive electrode 201, 30≤v1≤98 may be satisfied, where v1 is the volume ratio of the positive electrode active material 110 based on 100 of the sum of the volumes of the positive electrode active material 110 and the first solid electrolyte material 100 included in the positive electrode 201. In the case where 30≤v1 is satisfied, the battery can achieve a sufficient energy density. In the case where v1≤98 is satisfied, the battery 2000 can operate at a high output.

At least a portion of the surface of the positive electrode active material 110 may be coated with a coating material.

Examples of the coating material include a sulfide solid electrolyte, an oxide solid electrolyte, and a halide solid electrolyte. The sulfide solid electrolyte for use as the coating material may be the same material as any of the materials described as examples for the first solid electrolyte material 100. Examples of the oxide solid electrolyte for use as the coating material include: a Li—Nb—O compound, such as LiNbO₃; a Li—B—O compound, such as LiBO₂ or LisBO₃; a Li—Al—O compound, such as LiAlO₂; a Li—Si—O compound, such as Li₄SiO₄; a Li—Ti—O compound, such as Li₂SO₄ or Li₄Ti₅O₁₂; a Li—Zr—O compound, such as Li₂ZrO₃; a Li—Mo—O compound, such as Li₂MoO₃; a Li-V-O compound, such as LiV₂O₅; a Li—W—O compound, such as Li₂WO₄; and a Li—P—O compound, such as Li₃PO₄.

The positive electrode 201 may have a thickness of 10 μm or more and 500 μm or less. In the case where the positive electrode 201 has a thickness of 10 μm or more, the battery can achieve a sufficient energy density. In the case where the positive electrode 201 has a thickness of 500 μm or less, the battery 2000 can operate at a high output.

### [Solid Electrolyte Layer 202]

The solid electrolyte layer 202 is disposed between the positive electrode 201 and the negative electrode 203.

The solid electrolyte layer 202 includes a solid electrolyte material.

The solid electrolyte material included in the solid electrolyte layer 202 may be the same material as the first solid electrolyte material 100. In other words, the solid electrolyte layer 202 may include a material having the same composition as the composition of the first solid electrolyte material 100.

The solid electrolyte material included in the solid electrolyte layer 202 may be a halide solid electrolyte, a sulfide solid electrolyte, an oxide solid electrolyte, a polymer solid electrolyte, or a complex hydride solid electrolyte.

The oxide solid electrolyte that can be included in the solid electrolyte layer 202 can be, for example: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃PO₄ and N-substituted substances thereof; or glass or glass ceramics based on a Li—B—O compound, such as LiBO₂ or Li₃BO₃, to which Li₂SO₄, Li₂CO₃, or the like is added.

The polymer solid electrolyte that can be included in the solid electrolyte layer 202 can be, for example, a compound of a polymer compound and a lithium salt. The polymer compound may have an ethylene oxide structure. The polymer compound having an ethylene oxide structure can contain a lithium salt in a large amount. Accordingly, the ionic conductivity can be further enhanced. The lithium salt can be LiPF₆, LiBF₄, LiSbF₆, LiAsF₆, LiSO₃CF₃, LIN(SO₂CF₃)₂, LIN(SO₂C₂F₅)₂, LiN(SO₂CF₃)(SO₂C₄F₉), LiC(SO₂CF₃)₃, or the like. One lithium salt selected from the lithium salts described as examples can be used alone. Alternatively, a mixture of two or more lithium salts selected from the lithium salts described as examples can be used.

The complex hydride solid electrolyte that can be included in the solid electrolyte layer 202 can be, for example, LiBH₄—LiI or LiBH₄—P₂S₅.

The solid electrolyte layer 202 may include the solid electrolyte material as the main component. In other words, the solid electrolyte layer 202 may include the solid electrolyte material in, for example, 50% or more on a mass basis (i.e., 50 mass % or more) with respect to the entire solid electrolyte layer 202.

With the above configuration, the charge and discharge characteristics of the battery 2000 can be enhanced.

The solid electrolyte layer 202 may include the solid electrolyte material in, for example, 70% or more on a mass basis (i.e., 70 mass % or more) with respect to the entire solid electrolyte layer 202.

With the above configuration, the charge and discharge characteristics of the battery 2000 can be further enhanced.

The solid electrolyte layer 202 may include the solid electrolyte material as the main component and further include unavoidable impurities, or a starting material for use in synthesizing the solid electrolyte material, a by-product, a decomposition product, etc.

The solid electrolyte layer 202 may include the solid electrolyte material in, for example, 100% on a mass basis (i.e., 100 mass %) with respect to the entire solid electrolyte layer 202, except for unavoidably incorporated impurities.

With the above configuration, the charge and discharge characteristics of the battery 2000 can be further enhanced.

As described above, the solid electrolyte layer 202 may consist of the solid electrolyte material.

The solid electrolyte layer 202 may include two or more of the materials described as examples of the solid electrolyte material. For example, the solid electrolyte layer 202 may include a halide solid electrolyte and a sulfide solid electrolyte.

The solid electrolyte layer 202 may have a thickness of 1 μm or more and 300 μm or less. In the case where the solid electrolyte layer 202 has a thickness of 1 μm or more, the positive electrode 201 and the negative electrode 203 are less prone to be short-circuited. In the case where the solid electrolyte layer 202 has a thickness of 300 μm or less, the battery 2000 can operate at a high output.

### [Negative Electrode 203]

The negative electrode 203 includes a material having properties of occluding and releasing metal ions (e.g., lithium ions). The negative electrode 203 includes, for example, a negative electrode active material.

The negative electrode active material can be a metal material, a carbon material, an oxide, a nitride, a tin compound, a silicon compound, or the like. The metal material may be a simple substance of metal. Alternatively, the metal material may be an alloy. Examples of the metal material include lithium metal and a lithium alloy. Examples of the carbon material include natural graphite, coke, partially graphitized carbon, a carbon fiber, spherical carbon, artificial graphite, and amorphous carbon. From the viewpoint of capacity density, silicon, tin, a silicon compound, or a tin compound can be used.

The negative electrode 203 may include a solid electrolyte material. The solid electrolyte material may be any of the solid electrolyte materials described as examples of the material for the first solid electrolyte material 100 included in the positive electrode 201 or the solid electrolyte materials described as examples of the material for the solid electrolyte layer 202. With the above configuration, the lithium-ion conductivity inside the negative electrode 203 is enhanced, thereby enabling the battery 2000 to operate at a high output.

The negative electrode active material may have a median diameter of 0.1 μm or more and 100 μm or less. In the case where the negative electrode active material has a median diameter of 0.1 μm or more, the negative electrode active material and the solid electrolyte material can form a favorable dispersion state in the negative electrode. This enhances the charge and discharge characteristics of the battery 2000. In the case where the negative electrode active material has a median diameter of 100 μm or less, lithium diffuses at an enhanced rate in the negative electrode active material. This enables the battery 2000 to operate at a high output.

The negative electrode active material may have a larger median diameter than the solid electrolyte material that may be included in the negative electrode 203 has. With the above configuration, the negative electrode active material and the solid electrolyte material can form a favorable dispersion state.

In the volume ratio “v2:100-v2” between the negative electrode active material and the solid electrolyte material included in the negative electrode 203, 30≤v2≤95 may be satisfied, where v2 is the volume ratio of the negative electrode active material based on 100 of the sum of the volumes of the negative electrode active material and the solid electrolyte material included in the negative electrode 203. In the case where 30≤v2 is satisfied, the battery can achieve a sufficient energy density. In the case where v2≤95 is satisfied, the battery 2000 can operate at a high output.

The negative electrode 203 may have a thickness of 10 μm or more and 500 μm or less. In the case where the negative electrode 203 has a thickness of 10 μm or more, the battery 2000 can achieve a sufficient energy density. In the case where the negative electrode 203 has a thickness of 500 μm or less, the battery 2000 can operate at a high output.

At least one selected from the group consisting of the positive electrode 201, the solid electrolyte layer 202, and the negative electrode 203 may include a binder for the purpose of enhancing the adhesion between the particles. The binder is used in order to enhance the binding properties of the materials for the electrodes. Examples of the binder include polyvinylidene fluoride, polytetrafluoroethylene, polyethylene, polypropylene, an aramid resin, a polyamide, a polyimide, a polyamide-imide, polyacrylonitrile, a polyacrylic acid, polyacrylic acid methyl ester, polyacrylic acid ethyl ester, polyacrylic acid hexyl ester, a polymethacrylic acid, polymethacrylic acid methyl ester, polymethacrylic acid ethyl ester, polymethacrylic acid hexyl ester, polyvinyl acetate, polyvinylpyrrolidone, a polyether, a polyethersulfone, hexafluoropolypropylene, styrene-butadiene rubber, and carboxymethyl cellulose. Moreover, the binder can be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Furthermore, a mixture of two or more selected from the above may be used.

At least one selected from the group consisting of the positive electrode 201 and the negative electrode 203 may include a conductive additive for the purpose of enhancing the electronic conductivity. The conductive additive can be, for example, graphite, such as natural graphite or artificial graphite, carbon black, such as acetylene black or Ketjenblack, a conductive fiber, such as a carbon fiber or a metal fiber, fluorinated carbon, a metal powder, such as an aluminum powder, a conductive whisker, such as a zinc oxide whisker or a potassium titanate whisker, a conductive metal oxide, such as titanium oxide, or a conductive polymer compound, such as a polyaniline compound, a polypyrrole compound, or a polythiophene compound. In the case where a conductive carbon additive is used as the conductive additive, cost reduction can be achieved.

Examples of the shape of the battery 2000 according to Embodiment 1 include a coin type, a cylindrical type, a prismatic type, a sheet type, a button type, a flat type, and a stacked type.

The battery 2000 according to Embodiment 1 may be manufactured by, for example, preparing a material for the positive electrode, a material for the electrolyte layer, and a material for the negative electrode, and producing by a known method a stack composed of the positive electrode, the electrolyte layer, and the negative electrode disposed in this order.

### Embodiment 2

Embodiment 2 will be described below. The description overlapping that of Embodiment 1 will be omitted as appropriate.

FIG. 2 is a cross-sectional view schematically showing the configuration of a battery 3000 according to Embodiment 2.

The battery 3000 according to Embodiment 2 includes the positive electrode 201, the solid electrolyte layer 202, and the negative electrode 203. The solid electrolyte layer 202 is disposed between the positive electrode 201 and the negative electrode 203. The solid electrolyte layer 202 includes a first solid electrolyte layer 301 and a second solid electrolyte layer 302. The first solid electrolyte layer 301 is positioned between the positive electrode 201 and the negative electrode 203. The second solid electrolyte layer 302 is positioned between the first solid electrolyte layer 301 and the negative electrode 203. In FIG. 2, a configuration example of the battery 3000 is shown in which the first solid electrolyte layer 301 is in contact with the positive electrode 201 and the second solid electrolyte layer 302 is in contact with the negative electrode 203.

With the above configuration, it is possible to suppress an increase in the internal resistance of the battery 3000 during charge.

From the viewpoint of the reduction resistance of solid electrolyte materials, the solid electrolyte material included in the first solid electrolyte layer 301 may have a higher reduction potential than the solid electrolyte material included in the second solid electrolyte layer 302 has. With the above configuration, the solid electrolyte material included in the first solid electrolyte layer 301 can be used without being reduced. Therefore, the battery 3000 can have an enhanced charge and discharge efficiency.

For example, the second solid electrolyte layer 302 may include a sulfide solid electrolyte. Here, the sulfide solid electrolyte that can be included in the second solid electrolyte layer 302 has a lower reduction potential than the solid electrolyte material included in the first solid electrolyte layer 301 has. With the above configuration, the solid electrolyte material included in the first solid electrolyte layer 301 can be used without being reduced. Therefore, the battery 3000 can have an enhanced charge and discharge efficiency.

The first solid electrolyte layer 301 and the second solid electrolyte layer 302 each may have a thickness of 1 μm or more and 300 μm or less. In the case where the first solid electrolyte layer 301 and the second solid electrolyte layer 302 each have a thickness of 1 μm or more, the positive electrode 201 and the negative electrode 203 are less prone to be short-circuited. In the case where the first solid electrolyte layer 301 and the second solid electrolyte layer 302 each have a thickness of 300 μm or less, the battery 3000 can operate at a high output.

### EXAMPLES

The present disclosure will be described in more detail below with reference to examples.

### Example 1

### [Production of First Solid Electrolyte Material]

In an argon atmosphere, raw material powders LiBr, YBr₃, LiCl, and YCl₃ were weighed in a molar ratio of LiBr:YBr₃:LiCl:YCl₃=1:1:5:1. Subsequently, these were milled in a planetary ball mill (Type P-7 manufactured by Fritsch GmbH) at 600 rpm for 25 hours to obtain powdered Li₃YBr₂Cl₄ as the first solid electrolyte material. [Production of positive electrode active material]

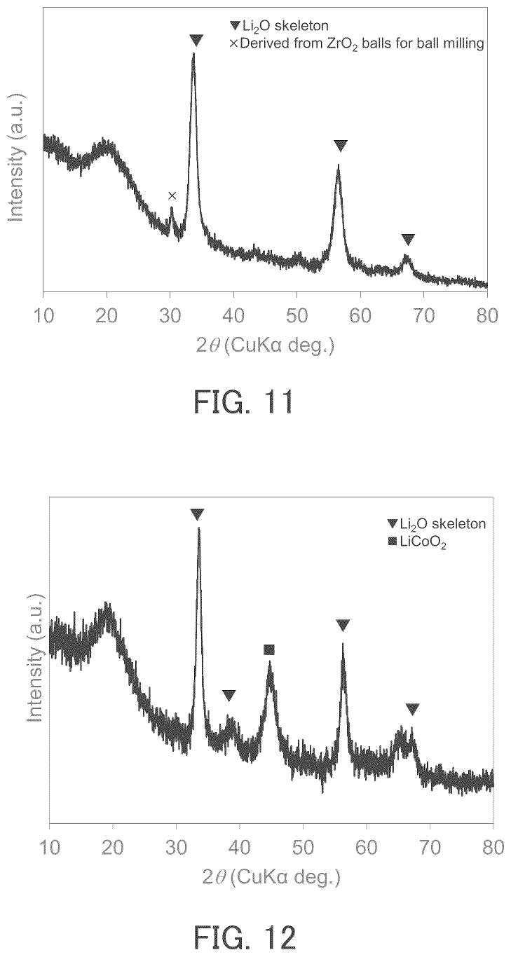

An amount of 2.00 g of Li₂O (manufactured by Kojundo Chemical Laboratory Co., Ltd.) and 1.19 g of Fe₂O₃ (manufactured by FUJIFILM Wako Pure Chemical Corporation) were weighed and milled in a planetary ball mill (Type P-7 manufactured by Fritsch GmbH) at 600 rpm for 100 hours to obtain a positive electrode active material. The positive electrode active material obtained was subjected to X-ray diffraction (XRD) measurement. The X-rays used were Cu-Kα radiation. FIG. 11 is a graph showing the XRD pattern of the positive electrode active material produced in Example 1. It is confirmed, as shown in FIG. 11, that the XRD pattern of the positive electrode active material produced in Example 1 had a peak derived from the Li₂O skeleton. In other words, the positive electrode active material produced in Example 1 included a material represented by the composition formula (1). It is confirmed that the above XRD pattern had an impurity peak derived from ZrO₂ balls for ball milling but did not have a peak or the like derived from a composite oxide including Li and Fe. This infers that the positive electrode active material consisted substantially of the material represented by the composition formula (1).

### [Production of Positive Electrode Material]

The positive electrode active material produced, the first solid electrolyte material produced, and vapor-grown carbon fibers (VGCF (manufactured by SHOWA DENKO K.K.)) serving as the conductive additive were weighed in a mass ratio of the positive electrode active material:the first solid electrolyte material:VGCF=58.25:38.75:3.0 and mixed in a mortar to obtain a positive electrode material of Example 1. VGCF is a registered trademark of SHOWA DENKO K.K.

### Example 2

### [Production of Positive Electrode Material]

A positive electrode material was produced in the same manner as in Example 1, except that Li₆PS₅Cl (manufactured by MSE Supplies LLC) was used as the first solid electrolyte material.

### Example 3

### [Production of Positive Electrode Active Material]

An amount of 2.00 g of Li₂O (manufactured by Kojundo Chemical Laboratory Co., Ltd.) and 1.63 g of LiCoO₂ (manufactured by Sigma-Aldrich Co., LLC.) were weighed and milled in a planetary ball mill (Type P-7 manufactured by Fritsch GmbH) at 600 rpm for 100 hours to obtain a positive electrode active material. The positive electrode active material obtained was subjected to XRD measurement. The X-rays used were Cu-Kα radiation. FIG. 12 is a graph showing the XRD pattern of the positive electrode active material produced in Example 3. It is confirmed, as shown in FIG. 12, that the XRD pattern of the positive electrode active material produced in Example 3 had a peak derived from the Li₂O skeleton and a peak derived from LiCoO₂. In other words, the positive electrode active material produced in Example 3 included a material represented by the composition formula (1).

### [Production of Positive Electrode Material]

A positive electrode material was produced in the same manner as in Example 1, except that the positive electrode active material produced in Example 3 was used.

### Example 4

### [Production of Positive Electrode Material]

A positive electrode material was produced in the same manner as in Example 3, except that Li₆PS₅Cl (manufactured by MSE Supplies LLC) was used as the first solid electrolyte material.

### Example 5

### [Production of Positive Electrode Active Material]

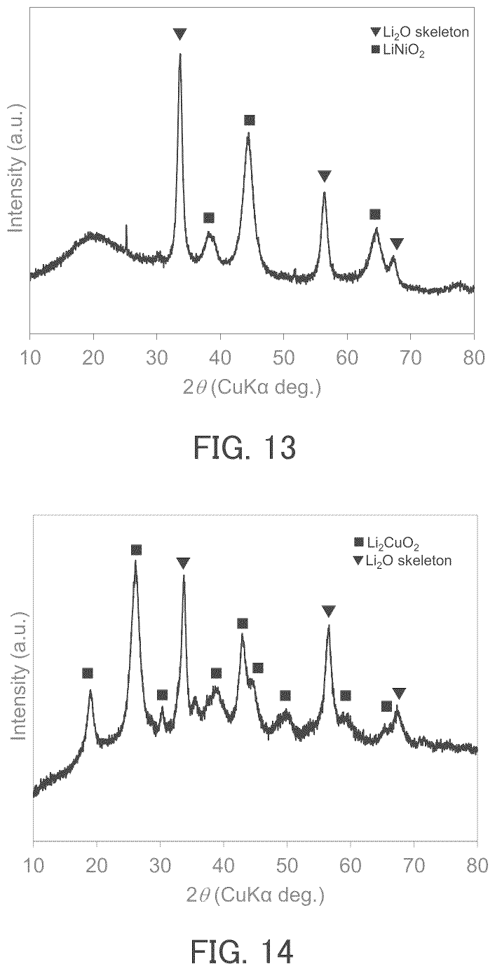

An amount of 2.00 g of Li₂O (manufactured by Kojundo Chemical Laboratory Co., Ltd.) and 1.63 g of LiNiO₂ (manufactured by Toshima Manufacturing Co., Ltd.) were weighed and milled in a planetary ball mill (Type P-7 manufactured by Fritsch GmbH) at 600 rpm for 100 hours to obtain a positive electrode active material. The positive electrode active material obtained was subjected to XRD measurement. The X-rays used were Cu-Kα radiation. FIG. 13 is a graph showing the XRD pattern of the positive electrode active material produced in Example 5. It is confirmed, as shown in FIG. 13, that the XRD pattern of the positive electrode active material produced in Example 5 had a peak derived from the Li₂O skeleton and a peak derived from LiNiO₂. In other words, the positive electrode active material produced in Example 5 included a material represented by the composition formula (1).

### [Production of Positive Electrode Material]

A positive electrode material was produced in the same manner as in Example 1, except that the positive electrode active material produced in Example 5 was used.

### Example 6

### [Production of Positive Electrode Material]

A positive electrode material was produced in the same manner as in Example 5, except that Li₆PS₅Cl (manufactured by MSE Supplies LLC) was used as the first solid electrolyte material.

### Example 7

### [Production of Positive Electrode Active Material]

An amount of 2.00 g of Li₂O (manufactured by Kojundo Chemical Laboratory Co., Ltd.) and 1.78 g of CuO (manufactured by FUJIFILM Wako Pure Chemical Corporation) were weighed and milled in a planetary ball mill (Type P-7 manufactured by Fritsch GmbH) at 600 rpm for 100 hours to obtain a positive electrode active material. The positive electrode active material obtained was subjected to XRD measurement. The X-rays used were Cu-Kα radiation. FIG. 14 is a graph showing the XRD pattern of the positive electrode active material produced in Example 7. It is confirmed, as shown in FIG. 14, that the XRD pattern of the positive electrode active material produced in Example 7 had a peak derived from the Li₂O skeleton and a peak derived from LiCuO₂. In other words, the positive electrode active material produced in Example 7 included a material represented by the composition formula (1).

### [Production of Positive Electrode Material]

A positive electrode material was produced in the same manner as in Example 1, except that the positive electrode active material produced in Example 7 was used.

### Example 8

### [Production of Positive Electrode Material]

A positive electrode material was produced in the same manner as in Example 7, except that Li₆PS₅Cl (manufactured by MSE Supplies LLC) was used as the first solid electrolyte material.

### <Evaluation of Battery>

### [Production of Battery]

Batteries of Examples 1 to 8 were each produced by the following procedure.

First, 80 mg of Li₆PS₅Cl was put into an insulating outer cylinder and pressure-molded at a pressure of 2 MPa. Subsequently, 20 mg of the first solid electrolyte material used as the positive electrode material in the example was put therein and pressure-molded at a pressure of 2 MPa. Furthermore, 12 mg of the positive electrode material was put therein and pressure-molded at a pressure of 720 MPa. Thus, a stack composed of the positive electrode and the solid electrolyte layer was obtained.

Subsequently, on one side of the solid electrolyte layer opposite to the other side in contact with the positive electrode, metallic In having a thickness of 200 μm, metallic Li having a thickness of 300 μm, and metallic In having a thickness of 200 μm were disposed in this order for two sets. These were pressure-molded at a pressure of 80 MPa to obtain a stack composed of the positive electrode, the solid electrolyte layer, and the negative electrode.

Subsequently, current collectors made of stainless steel were provided on the top and the bottom of the stack composed of the positive electrode, the solid electrolyte layer, and the negative electrode, and current collector leads were attached to the current collectors.

Lastly, an insulating ferrule was used to block the inside of the insulating outer cylinder from the outside air atmosphere to hermetically seal the cylinder to obtain a battery.

Thus, the batteries of Examples 1 to 8 described above were produced.

### [Charge Test]

A charge test was performed on the batteries of Examples 1 to 8 described above under the following conditions.

The batteries were each placed in a thermostatic chamber set at 25° C.

Constant-current charge was performed at a current value of 63 μA for 33 hours and 20 minutes, so that the battery was charged to 300 mAh/g. The end-of-charge voltage was set to 3.2 V vs. the In—Li alloy negative electrode. Subsequently, constant-current discharge was performed. The end-of-discharge voltage was set to 0.88 V (vs. In—Li). The In—Li alloy has an average potential of 0.62 V vs. Li.

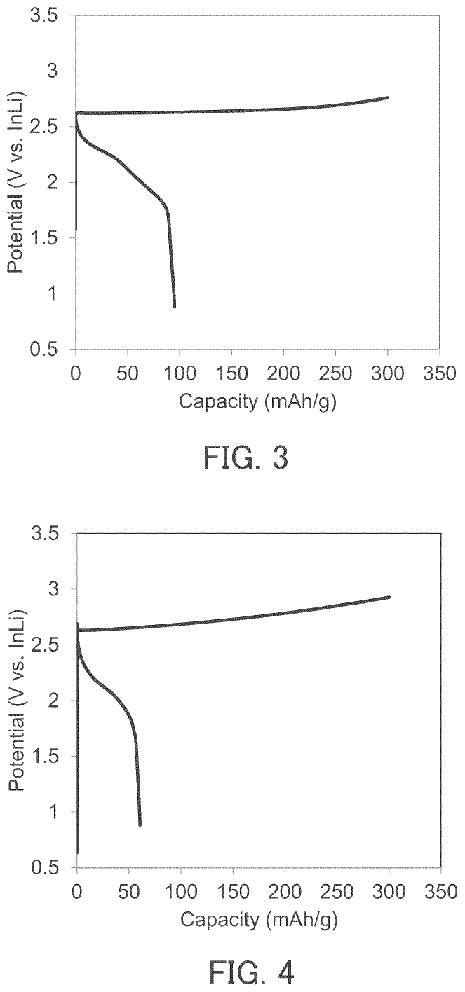

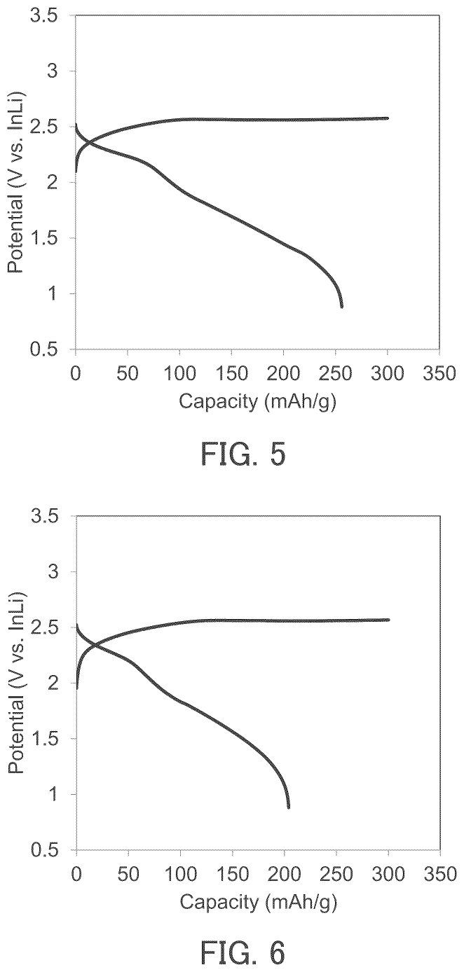

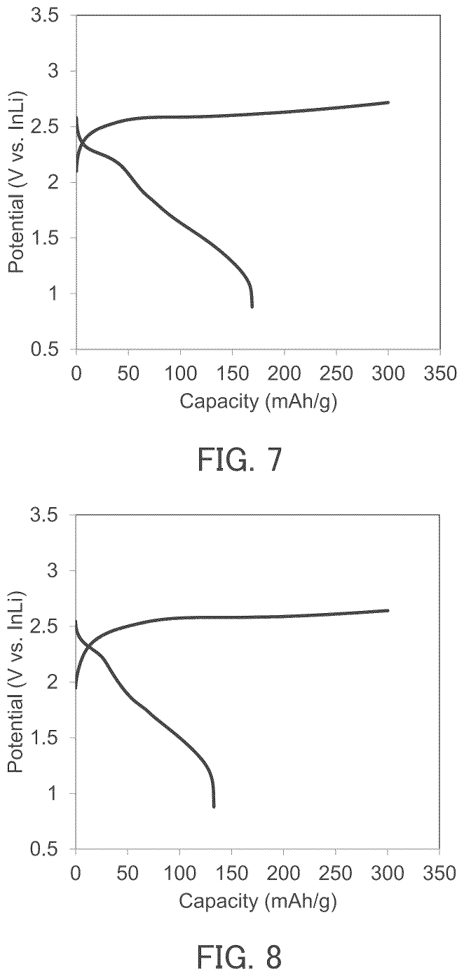

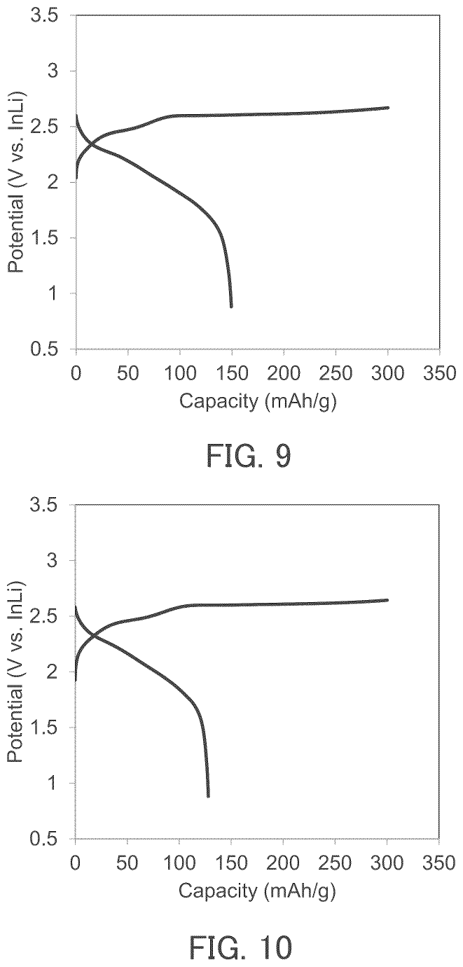

FIG. 3 is a graph showing the charge and discharge curves of the battery of Example 1. FIG. 4 is a graph showing the charge and discharge curves of the battery of Example 2. FIG. 5 is a graph showing the charge and discharge curves of the battery of Example 3. FIG. 6 is a graph showing the charge and discharge curves of the battery of Example 4. FIG. 7 is a graph showing the charge and discharge curves of the battery of Example 5. FIG. 8 is a graph showing the charge and discharge curves of the battery of Example 6. FIG. 9 is a graph showing the charge and discharge curves of the battery of Example 7. FIG. 10 is a graph showing the charge and discharge curves of the battery of Example 8. As shown in FIG. 3 to FIG. 10, it is confirmed that, by including the positive electrode including the positive electrode active material including a material represented by the composition formula (1), the batteries of Examples 1 to 8 are operable in a potential range where no decomposition of the solid electrolyte occurs, where the solid electrolyte has 3.2 V or less vs. the In—Li alloy negative electrode, that is, 3.9 V or less vs. Li.

### INDUSTRIAL APPLICABILITY

The battery of the present disclosure can be used as, for example, an all-solid-state lithium-ion secondary battery.

What is claimed is:

1. A battery comprising:
a positive electrode;
a negative electrode; and
a solid electrolyte layer positioned between the positive electrode and the negative electrode, wherein
the positive electrode includes a positive electrode material,
the positive electrode material includes a positive electrode active material and a first solid electrolyte material, and
the positive electrode active material includes a material represented by the following composition formula (1):
(Li_{2-α1}M1_{α1})O Formula (1)
in the composition formula (1),
M1 is at least one selected from the group consisting of transition metal elements, and
α1 satisfies 0<α1<2.

2. The battery according to claim 1, wherein
the M1 is at least one selected from the group consisting of Fe, Co, Ni, and Cu.

3. The battery according to claim 1, wherein
the first solid electrolyte material includes: Li; at least one selected from the group consisting of metalloid elements and metal elements other than Li; and at least one selected from the group consisting of Cl and Br.

4. The battery according to claim 3, wherein
the first solid electrolyte material includes a material represented by the following composition formula (2):
Li_{α2}M2_{β2}X_{γ2}O_{δ2} Formula (2)
in the composition formula (2),
α2, β2, and γ2 are each a value greater than 0, and δ2 is a value equal to or greater than 0,
M2 is at least one selected from the group consisting of metalloid elements and metal elements other than Li, and
X is at least one selected from the group consisting of Cl and Br.

5. The battery according to claim 4, wherein
the M2 includes at least one selected from the group consisting of Y and Ta.

6. The battery according to claim 4, wherein
the composition formula (2) satisfies:
$$1 \leq α2 \leq 4 ;$$
$$0 < β2 \leq 2 ;$$
$$3 \leq γ2 < 7 ; and$$
$$0 \leq δ2 \leq 2.$$

7. The battery according to claim 1, wherein
the first solid electrolyte material includes a sulfide solid electrolyte.

8. The battery according to claim 7, wherein
the sulfide solid electrolyte is Li₆PS₅Cl.

9. The battery according to claim 1, wherein
the solid electrolyte layer includes a first solid electrolyte layer and a second solid electrolyte layer, and
the second solid electrolyte layer is positioned between the first solid electrolyte layer and the negative electrode.

10. The battery according to claim 1, wherein
the positive electrode active material further includes a composite oxide including Li and the M1.
